(19) United States
(12) Patent Application Publication
(10) Pub. No.: US 2006/0055913 A1
(43) Pub. Date: Mar. 16, 2006

(54) Phase distribution measuring instrument and phase distribution measuring method

(75) Inventors: Haruyoshi Toyoda, Shizuoka (JP); Naohisa Mukozaka, Shizuoka (JP); Munenori Takumi, Shizuoka (JP)

Correspondence Address: MORGAN LEWIS & BOCKIUS LLP, 1111 PENNSYLVANIA AVENUE NW, WASHINGTON, DC, 20004, US

(73) Assignee: HAMMAMATSU PHOTONICS K.K., HAMAMATUS-SHI SHIZUOKA 435-8558 (JP)

(21) Appl. No.: 10/530,048

(22) PCT Filed: Oct. 3, 2003
(86) PCT No.: PCT/JP03/12728

§ 371 Date: Apr. 1, 2005

(30) Foreign Application Priority Data
Oct. 3, 2002 (JP) 2002-29104

(51) Int. Cl. G01J 1/00

(52) U.S. Cl. 356/121

(57) ABSTRACT

A fly-eye lens 30 formed by arranging a plurality of condensing lenses 32 in a matrix on a plane, a CMOS sensor 10 having a light receiving surface arranged in parallel to the fly-eye lens 30 at a distance corresponding to the focal length of the condensing lenses 32, and a phase calculation device 20 are provided. A center position calculating part 243 calculates the center positions of bright spots (focal points) of focal point images on the light receiving surface by comparison with luminances of adjacent pixels. A centroid data processing part 245 calculates the 0-order moment (total of bright spot luminances in the centroid operating region), first-order moment in the x direction, and first-order moment in the y direction of the luminance in a centroid operating region centered on the bright spot center position. A centroid position calculating part 261 calculates the centroid position of each bright spot based on these centroid data.

### TECHNICAL FIELD

The present invention relates to a phase distribution measuring apparatus and a phase distribution measuring method.

### BACKGROUND ART

In conventional phase distribution measuring apparatuses and phase distribution measuring methods, a bright spot centroid operating region is fixed to a section of the light receiving surface corresponding to each condensing lens.

### DISCLOSURE OF THE INVENTION

However, in conventional phase distribution measuring apparatuses, when a bright spot greatly deviates, the bright spot is greatly displaced from the centroid operating region, so that an accurate centroid position calculation becomes impossible.

Therefore, the invention was made in view of the above-mentioned problem, and an object thereof is to provide a phase distribution measuring apparatus with which the centroid position can be accurately calculated even when the bright spot greatly deviates.

In order to achieve the above-mentioned object, a phase distribution measuring apparatus of the invention comprises an image pickup device that includes a fly-eye lens composed of a plurality of condensing lenses arranged in a matrix on a plane and a plurality of light receiving elements arranged in a matrix on a light receiving surface, and is arranged so that the light receiving surface becomes parallel to the plane at a distance corresponding to the focal length of the condensing lenses, and a phase calculating device that calculates a phase distribution of light made incident on the fly-eye lens from data outputted from the image pickup device, wherein the phase calculating device comprises a center position calculation means that calculates bright spot center positions at which the luminance on the light receiving surface becomes maximum and a centroid position calculation means that calculates the centroid positions of the luminances in centroid operating regions centered on the luminance center positions.

Since the centroid operating regions are set based on the bright spot center positions calculated by the center position calculation means, the centroid operating regions also move according to the deviations of the bright spots. Therefore, even when the bright spots greatly deviate, it becomes possible to calculate the accurate centroid positions.

Preferably, in the phase distribution measuring apparatus of the invention, the phase calculating device further comprises a bright spot area calculation means that calculates the areas with luminances exceeding a predetermined threshold in a predetermined region centered on the luminance center positions, and the centroid operating regions are set to occupy areas exceeding the areas calculated by the bright spot area calculation means.

Since the centroid operating regions are set so as to exceed the luminance areas calculated by the bright spot area calculation means, the centroid operating regions more reliably include the bright spots.

Preferably, in the phase distribution measuring apparatus of the invention, the center position calculation means calculates bright spot center positions based only on data of luminances exceeding a predetermined reference value in luminance data, and the centroid position calculation means calculates centroid positions based only on the data exceeding the reference value in the luminance data.

Since operation is carried out based only on the data of luminances exceeding the predetermined reference value in luminance data, noise occurring when the image pickup device picks-up images is eliminated, and the data processing amount is reduced.

Preferably, in the phase distribution measuring apparatus of the invention, the phase calculating device further comprises a smoothing means which converts luminance data of each light receiving element into a weighted average of the same and luminance data of adjacent light receiving elements.

By this smoothing, noise occurring when the image pickup device picks-up images is eliminated.

Preferably, in the phase distribution measuring apparatus of the invention, the phase calculating device further comprises a luminance moment calculation means that calculates the moments of the luminances in the centroid operating region, the center position calculation means and the luminance moment calculation means are formed of a hardware operational circuit, and the centroid position calculation means calculates the centroid positions based on outputs of the hardware operational circuit.

Since operations up to the luminance moment calculation with a large amount of data to be processed are executed by the hardware operational circuit, high-speed operations become possible.

### BRIEF DESCRIPTION OF THE DRAWINGS

FIG. 1 is a schematic view of the construction of a phase distribution measuring apparatus 1;

FIG. 2 is a diagram showing the positional relationship between the fly-eye lens 30 and the light receiving surface 11 shown in FIG. 1;

FIG. 3 is a functional diagram of the CMOS sensor 10 and the phase calculating device 20 shown in FIG. 1;

FIG. 4 is a circuit diagram of the CMOS sensor 10;

FIG. 5 is a circuit diagram of the detailed construction of the integrating circuit 220 shown in FIG. 4;

FIG. 6 is a circuit diagram of a smoothing part 242;

FIG. 7 is a circuit diagram of a center position calculating part 243;

FIG. 8 is a circuit diagram of a bright spot area calculating part 244 (an area operating region is set to 3×3 lines as an example);

FIG. 9 is a circuit diagram of a centroid data processing part 245 (a centroid operating region is set to 3×3 lines as an example);

FIG. 10 is a flowchart of operation procedures of the CMOS sensor 10 and a phase calculating device 20;

FIG. 11A is a diagram showing an example of digital image data P(n), and FIG. 11B is a partial enlarged view of FIG. 11A;

FIG. 12 is a graph showing the relationship between the centroid position deviation and the incidence angle deviation (phase lag) of a measuring target laser beam; and

FIG. 13 is a graph showing the results of measurement of the phase distribution measuring apparatus in which the centroid operating region with respect to each condensing lens is fixed.

### BEST MODES FOR CARRYING OUT THE INVENTION

Hereinafter, a preferred embodiment of the phase distribution measuring apparatus 1 of the invention is described in detail with reference to the accompanying drawings.

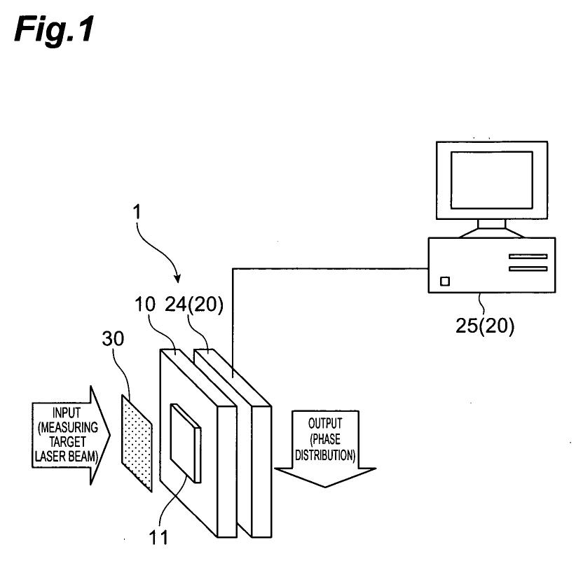

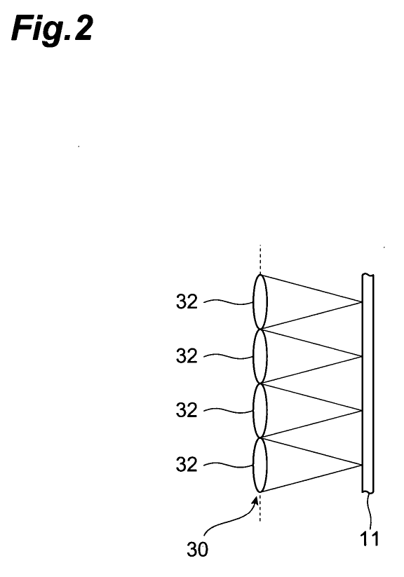

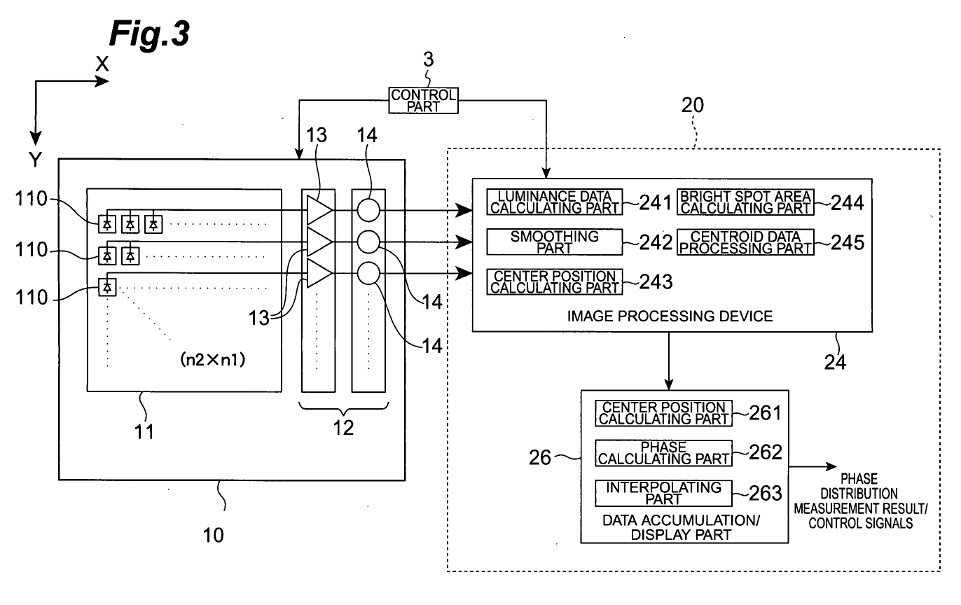

First, the construction of the phase distribution measuring apparatus 1 is described. FIG. 1 is a schematic view of the construction of the phase distribution measuring apparatus 1. FIG. 2 is a diagram showing the positional relationship between the fly-eye lens 30 and the light receiving surface 11 shown in FIG. 1. FIG. 3 is a functional diagram of the CMOS sensor 10 and the phase calculating device 20 shown in FIG. 1. As shown in FIG. 1, the phase distribution measuring apparatus 1 comprises the fly-eye lens 30, the CMOS sensor 10, an image processing device 24, and a computer 25. The fly-eye lens 30 is constructed by arranging condensing lenses 32 with a focal length of 20 mm in a matrix at intervals of 250 μm on a plane.

As shown in FIG. 3, the CMOS sensor 10 has the light receiving surface 11 including photoelectrical converting parts (CMOS) 120 formed in a matrix (n2 lines of CMOS arrays composed of n1 line of photoelectrical converting parts 120 are aligned) and n2 lines of A/D converters 210 aligned corresponding to the respective CMOS arrays 110. Each A/D converter 210 includes an amplifying part 13 and an A/D converting part 14, and amplifies and converts an output of the photoelectrical converting part 120 into 4-bit (16-tone) digital data. As shown in FIG. 2, the CMOS sensor 10 is arranged so that the light receiving surface 11 becomes parallel to the fly-eye lens 30 and the focal points of the condensing lenses 32 are positioned on the light receiving surface 11.

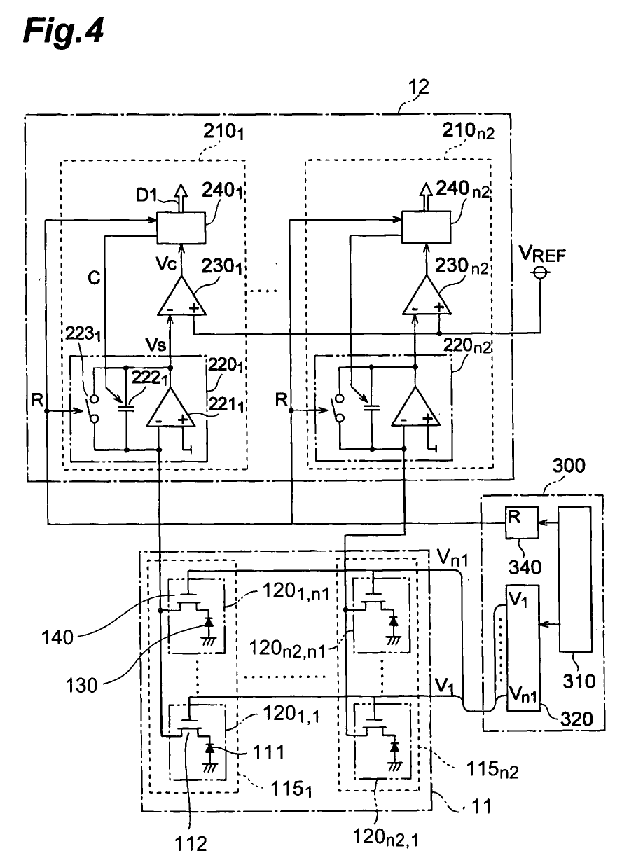

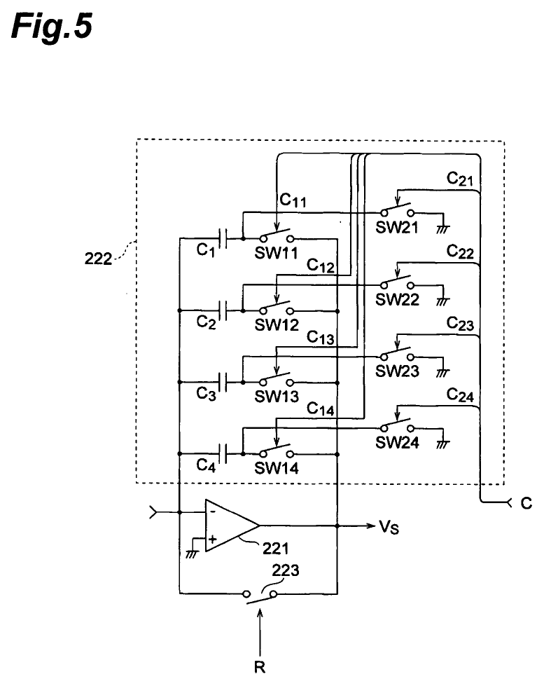

FIG. 4 is a circuit diagram of the CMOS sensor 10. FIG. 5 is a circuit diagram showing the detailed construction of the integrating circuit 220 shown in FIG. 4. With reference to FIG. 4 and FIG. 5, the circuitry of the CMOS sensor 10 is described. As shown in FIG. 4, the photoelectrical converting part 120 is constructed so that a photodiode 130 that generates charges according to luminances of received light and a MOSFET 140 that outputs the charges accumulated in the photodiode 130 in response to a vertical scanning signal Vi (i=1 through n1) are arranged as one set.

The A/D converter 210j (j=1 through n2) of the signal processing part 12 comprises an integrating circuit 220j (j=1 through n2) including a charge amplifier 221j (j=1 through n2), a comparator circuit 230j (j=1 through n2), and a capacitance control mechanism 240j (j=1 through n2).

The integrating circuit 220 comprises a charge amplifier 221 that inputs output signals from the CMOS arrays 110 and amplifies charges of the input signals, a variable capacitance part 222 one end of which is connected to an input terminal of the charge amplifier 221 and the other end of which is connected to an output terminal of the charge amplifier 221, and a switching element 223 one end of which is connected to the input terminal of the charge amplifier 221 and the other end of which is connected to the output terminal to switch an integrating operation and a non-integrating operation of the integrating circuit 220 by being turned ON and OFF in response to a reset signal R.

The variable capacitance part 222 comprises capacitance elements C1 through C4 one-side terminals of which are connected to the input terminal of the charge amplifier 221, switching elements SW11 through SW14 that are connected between the other terminals of the capacitance elements C1 through C4 and the output terminal of the charge amplifier 221 and open and close in response to capacitance instruction signals C11 through C14, and switching elements SW21 through SW24 one-side terminals of which are connected between the capacitance elements C1 through C4 and the switching elements SW11 through SW14 and the other terminals of which are connected to the GND level, and which open and close in response to capacitance instruction signals C21 through C24. The capacitances C1 through C4 of the capacitance elements C1 through C4 satisfy the following relationships.
C1=2C2=4C3=8C4
C0=C1+C2+C3+C4
Herein, C0 is the maximum capacitance required in the integrating circuit 220, and satisfies the following relationship when the saturated charge of the photoelectrical converting part 120 is defined as Q0, and the reference voltage is defined as V_{REF}.
C0=Q0/V_{REF}

The comparator circuit 230 compares the value of an integral signal Vs outputted from the integrating circuit 220 with the reference value V_{REF} and outputs a comparison result signal Vc. The capacitance control mechanism 240 outputs a capacitance instruction signal C to be notified for the variable capacitance part 222 within the integrating circuit 220 from the value of the comparison result signal Vc, and outputs a digital signal D1 corresponding to the capacitance instruction signal C.

Furthermore, the CMOS sensor 10 has a timing control part 300 (corresponding to a part of the control part 3 shown in FIG. 3) that transmits an operation timing instruction signal to the photoelectrical converting part 120 and the signal processing part 12. The timing control part 300 comprises a basic timing part 310 that generates basic timings for clock control of all circuits, a vertical shift register 320 that generates vertical scanning signals Vi (i=1 through n1) according to a vertical scanning instruction notified from the basic timing part 310, and a control signal part 340 that generates reset instruction signals R.

Digital signals transferred and outputted successively from the most significant bit (MSB) for each CMOS array 110 from the signal processing part 12 constructed as described above are stored in a buffer for a data length (4 bits) corresponding to one pixel, and parallel-serial converted into an output image.

Returning to FIG. 3, the image processing device 24 and the data accumulation/display part 26 as a functional component of the computer 25 are described. The image processing device 24 and the data accumulation/display part 26 form the phase calculating device 20 that calculates the phase distribution of light made incident on the fly-eye lens 30 based on outputs of the CMOS sensor 10.

The image processing device 24 comprises, as functional components, a luminance data calculating part 241, a smoothing part 242, a center position calculating part 243, a bright spot area calculating part 244, and a centroid data processing part 245. The luminance data calculating part 241 has a function for composing digital image data of focal point images on the light receiving surface 11 by analyzing and arranging the outputs of the CMOS sensor 10.

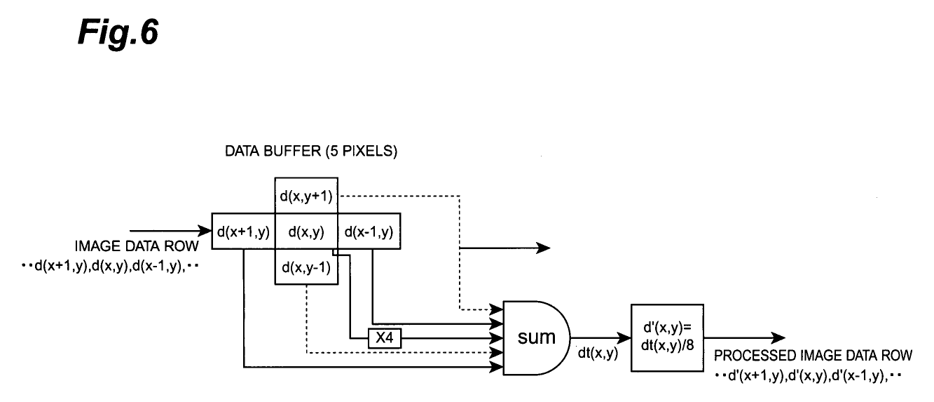

The smoothing part 242 has a function for smoothing by converting luminance data of each pixel in the digital image data calculated by the luminance data calculating part 241 into a weighted average of the same and luminance data of pixels positioned on the upper, lower, left, and right sides. FIG. 6 is a circuit diagram of the smoothing part 242. From the digital image data, pixels to be smoothed and luminance values of pixels on the upper, lower, and left, and right sides are extracted and stored in the data buffer. These luminance data are weighted-averaged by an adding circuit and a dividing circuit.

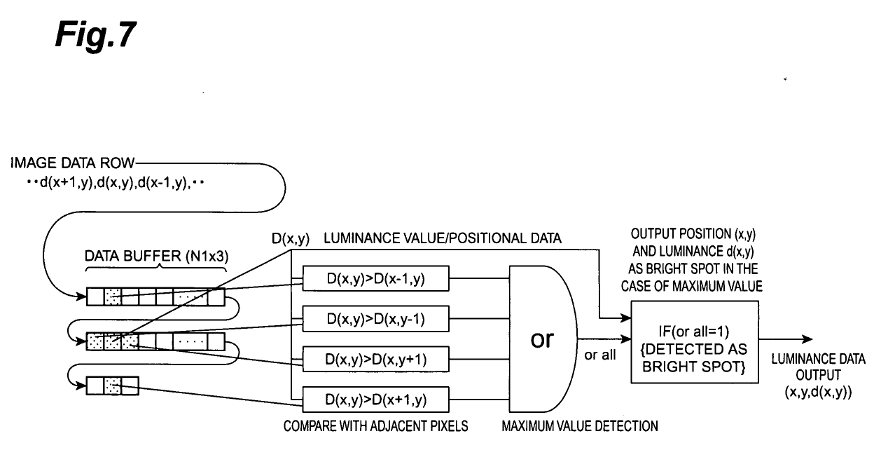

The center position calculating part 243 has a function for calculating the center positions of the bright spots in the smoothed digital image data. FIG. 7 is a circuit diagram of the center position calculating part 243. The smoothed data row is inputted into a 3-line data buffer. In the data stored therein, it is judged whether or not the central data d(x,y) of 3×3-pixel data is larger than data values of adjacent pixels. When d(x,y) is larger than all adjacent data, “maximum=bright spot” is judged, and the position (x,y) and the luminance value d(x,y) thereof are outputted.

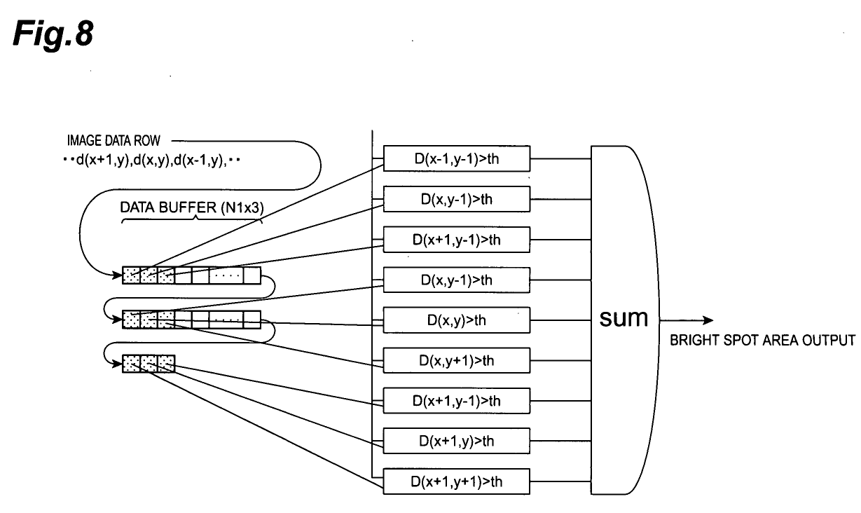

The bright spot area calculating part 244 has a function for calculating the area (pixel number) of each bright spot. FIG. 8 is a circuit diagram of the bright spot area calculating part 244 (as an example, the area operating region is set to 3×3 lines). For 3×3-pixel data stored in the 3-line data buffer, the respective pixel values are compared with a threshold th by a comparator, and the number of pixels larger than the threshold th is calculated by a summing circuit.

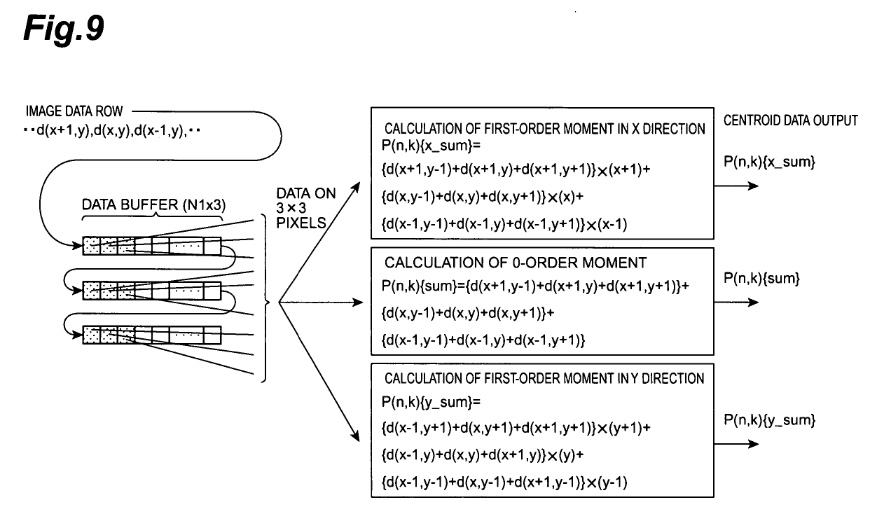

The centroid data processing part 245 has a function for calculating centroid data in a centroid operating region upon setting the centroid operating region based on the area (pixel number) of each bright spot. This centroid data contains 0-order luminance moment (the total of bright spot luminances in the centroid operating region, and first-order luminance moment in the x direction (the horizontal direction on the light receiving surface 11 or the digital image data) and first-order luminance moment in the y direction (the vertical direction in the light receiving surface 11 or the digital image data). FIG. 9 is a circuit diagram of the centroid data processing part 245 (as an example, the centroid operating region is set to 3×3 lines). With respect to the data of 3×3 pixels stored in the 3-line data buffer, the first-order luminance moment in the x direction, the first-order luminance moment in the y direction, and the 0-order luminance moment are calculated.

The data accumulation/display part 26 includes a centroid position calculating part 261, a phase calculating part 262, and an interpolating part 263. The centroid position calculating part 261 has a function for calculating the centroid positions of the bright spots based on the centroid data.

The phase calculating part 262 has a function for calculating phases based on deviations of the centroid positions of the bright spots from the centroid initial positions (centroid positions of the bright spots without phase lag).

The interpolating part 263 has a function for acquiring a continuous phase distribution by interpolating the calculated phase data.

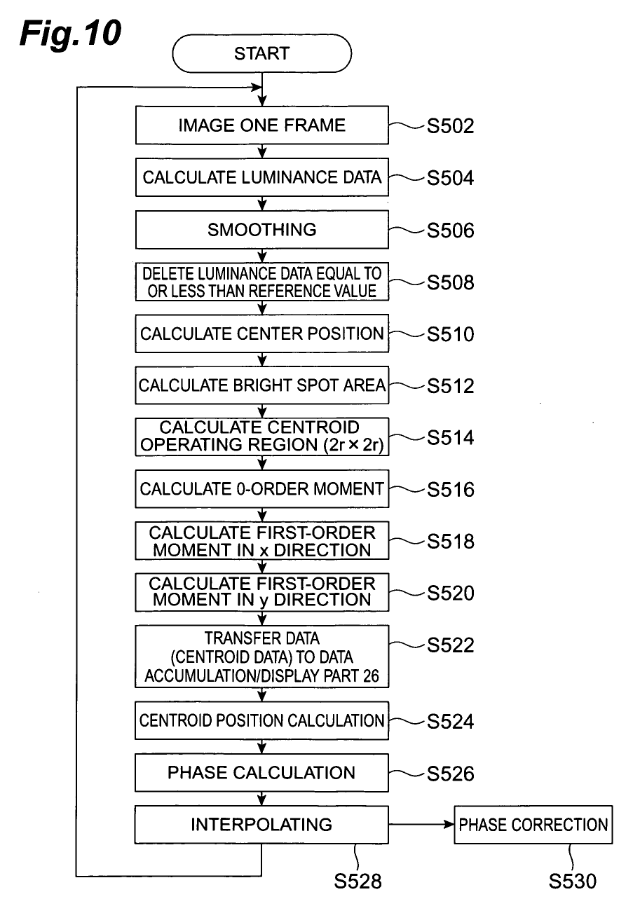

Next, the operations of the phase distribution measuring apparatus 1 are described. When a measuring target laser beam passes through the fly-eye lens 30, images of focal points corresponding to the respective condensing lenses 32 are generated on the light receiving surface 11. The images are picked-up by the CMOS sensor 10 and data-processed by the phase calculating device 20. FIG. 10 is a flowchart showing operation procedures of the CMOS sensor 10 and the phase calculating device 20. Hereinafter, the operations of the CMOS sensor 10 and the phase calculating device 20 are described with reference to the flowchart of FIG. 10.

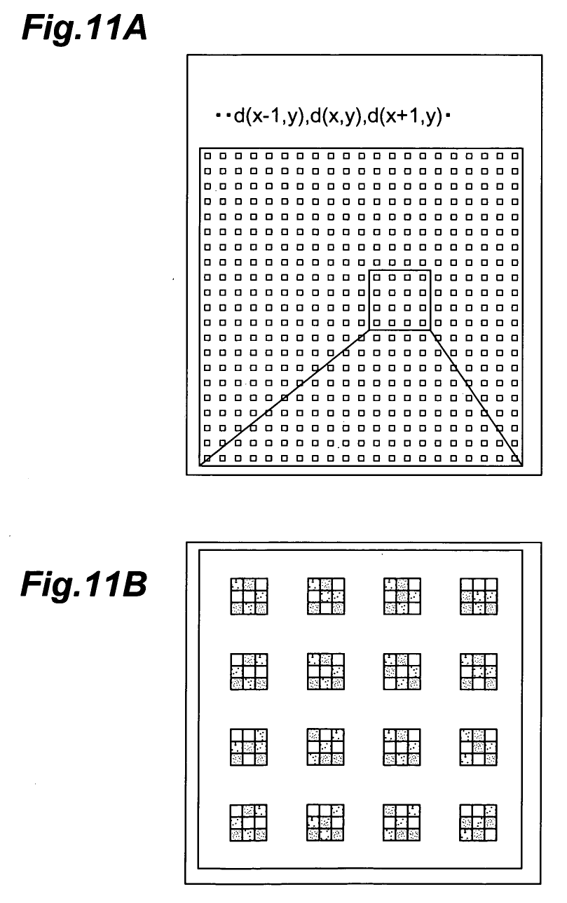

First, the CMOS sensor 10 scans the images on the light receiving surface 11 to pick-up one frame (S502). Simultaneously, the luminance data calculating part 241 analyzes and arranges the luminances (4-bit digital data) of the pixels outputted from the CMOS sensor 10 to compose one-frame digital image data P(n) (n: frame number) (S504). FIG. 11A shows an example of the digital image data P(n), and FIG. 11B shows a partial enlarged view thereof.

The smoothing part 242 applies smoothing to the digital image data P(n) (S506). Concretely, weighted average of the luminance of each pixel and luminances of the pixels on the upper, lower, and left, and right sides is repeated twice. The algorithm of the smoothing is shown as follows.
d_{new} (x,y)=[d(x−1,y)+d(x,y−1)+d(x+1,y)+d(x,y+1)+4d(x,y)]/8; d(x,y)=d_{new} (x,y);
d_{new} (x,y)=[d(x−1,y)+d(x,y−1)+d(x+1,y)+d(x,y+1)+4d(x,y)]/8; d(x,y)=d_{new} (x,y);
d indicates a luminance of a pixel, (x,y) indicates the coordinates of the pixel on the light receiving surface 11 or the digital image data P(n).

Furthermore, the smoothing part 242 deletes the luminance data equal to or lower than a predetermined reference value from the smoothed digital image data P(n) (S508). By such smoothing and deletion of luminance data equal to or lower than the reference value, noise occurring in the process of imaging of the CMOS sensor 10 can be reduced. Since unnecessary data is deleted, the operating speed is improved.

The center position calculating part 243 calculates the center position and luminance of each bright spot in the smoothed digital image data P(n) (S510). In detail, the luminance of each pixel is compared with the luminances on the upper, lower, left, and right sides, and when the luminance of this pixel is higher than all luminances on the upper, lower, left, and right sides, this pixel is judged as being at the center position of the bright spot. The algorithm for the center position calculation is shown as follows.
k=0;
for (x=0; x<pixel number in X direction; x++)[
for (y=0; y<pixel number in Y direction; y++)[
if(((d(x,y)>d(x−1,y) & ((d(x,y)>d(x,y−1) & ((d(x,y)>d(x+1,y)) & ((d(x,y)>d(x,y+1)))[
p(n,k)[d]=d(x,y); p(n,k)[x]=x; p(n,k)[y]=y; k=k+1;]))
p(n,k) [d] indicates the luminance at the k-th bright spot center position of the n-th frame, p(n,k)[x] indicates the x coordinate of the k-th bright spot center position of the n-th frame, and the p(n,k) [y] indicates the y coordinate of the k-th bright spot center position of the n-th frame.

The bright spot area calculating part 244 calculates the area (pixel number) of each bright spot (S512). In detail, the number of pixels with luminances exceeding the predetermined threshold th in a predetermined region (2 h×2 h) centered on the bright spot center position is counted. The algorithm for the bright spot area calculation is shown as follows.
p(n,k)[s]=0;
for (xx=x−h; xx<x+h;xx++)[
for (yy=y−h; yy<y+h;yy++)[
if (d(x,y)>th)[
p(n,k)[s]=p(n,k)[s]+1;]]]

The centroid data processing part 245 calculates a centroid operating region (2 r×2 r) corresponding to the bright spot area calculated by the bright spot area calculating part 244 for each bright spot. r is set so as to satisfy, for example, (r−1)²≦bright spot area≦4 r².

The centroid data processing part 245 calculates centroid data (0-order luminance moment p(n,k) [sum], first-order luminance moment p(n,k) [x_sum] in the x direction, and first-order luminance moment p(n,k) [y_sum]) in the y direction of each bright spot) (S516, S518, S520), and transfers the centroid data to the data accumulation/display part 26 on the rear stage (S522). The algorithm for the centroid data calculation is shown as follows.
p(n,k)[sum]=0; p(n,k)[x_sum]=0; p(n,k)[y_sum]=0;
for (xx=x−r; xx<x+r; xx++)[
for (yy=y−r; yy<y+r; yy++)[
p(n,k)[sum]=p(n,k)[sum]+d(xx,yy);
p(n,k)[x_sum]=p(n,k)[x_sum]+xx* d(xx,yy);
p(n,k)[y_sum]=p(n,k)[y_sum]+yy* d(xx,yy);]]

The above-described processing of the image processing device 20 is carried out by a hardware circuit. Recently, as a device on which hardware for carrying out image operation processing as described above is easily developed and mounted, an FPGA (Field Programmable Gate Array) has been made practicable, and it has become possible to efficiently carry out operations for realizing processing suitable for operating targets on hardware. Furthermore, circuit designing with a description of software processing contents has become possible by using HDL (hardware description language), so that hardware for desired image processing can be prepared easily. By image processing on hardware thus prepared, operations at a higher speed than in the case of image processing on software by a general-purpose circuit have become possible. The CMOS sensor 10 realizes a high-speed frame rate at a level of 1 kHz due to serial-parallel processing of the A/D converter 210 corresponding to each CMOS array 210, and the image processing device 20 can also realize a high-speed response at a level of 1 kHz by hardware.

Furthermore, the data to be outputted to the data accumulation/display part 26 is centroid data and other characteristic amount data, so that the data amount to be processed by the data accumulation/display part 26 can be reduced. For example, in the case of a sensor including a photoelectrical converting part 120 for 128×128 pixels, if image data is outputted without change, the communications data amount is 128×128 bits=16 Kbytes, however, by using the luminance data and the centroid data obtained by data processing as communications data, data per bright spot can be reduced to 64 bits=8 bytes. Therefore, when data on 100 bright spots exists in one image plane, the communications data amount can be compressed to a total of 800 bytes (approximately, 1/20 of the image) and outputted. This compression rate becomes higher as a higher-resolution light receiving part is used.

The centroid position calculating part 261 calculates the centroid position of each bright spot based on the centroid data (S524). The algorithm for the centroid position calculation is shown as follows.
(bright spot centroid position in x direction)pₓ=p(n,k)[x_sum]/p(n,k)[sum];
(bright spot centroid position in y direction)p_{y}=p(n,k)[y_sum]/p(n,k)[sum];

From the above-mentioned calculation, the centroid position can be calculated by sub pixels. Namely, the centroid position can be calculated in units smaller than the units of pixels.

The phase calculating part 262 calculates the phase wₓ in the x direction and the phase w_{y} in the y direction based on the centroid position of each bright spot (S526) . The algorithm for phase calculation is shown as follows.
(phase in x direction) wₓ=(pₓ−pₓ₀)/f
(phase in y direction) w_{y}=(p_{y}−p_{y0})/f
(pₓ₀,p_{y0}) indicates the initial values of the centroid position (centroid position of the luminance without phase lag), and f indicates the focal length of the condensing lens 32.

The interpolating part 263 acquires phase distribution data by interpolating phase discrete data obtained in S526 (S528). Namely, from the phase data calculated for each bright spot corresponding to each condensing lens 32, interpolation operation between blocks and interpolation calculation are carried out under a constrained condition of continuity to peripheral blocks. For example, when linear interpolation is carried out, from the phase (wₓ,w_{y}) of a certain block (x,y) and values of peripheral blocks thereof, the phase (w′ₓ,w′_{y}) of the middle position (x′,y′) of the blocks is expressed as follows by general linear interpolation calculation.
w′ₓ=wₓ₀+(wₓ₁−wₓ₀)*(x′−x₀)/(x₁−x₀)
w′_{y}=w_{y0}+(w_{y1}−wₓ₀)*(y′−y₀)/(y₁−y₀)
However, the calculation above should satisfy x₀<x′<x₁, y₀<y′<y₁.

Continued from S528, the above-mentioned processing is repeated for the next frame.

In the above-mentioned embodiment, common coordinates are used for all bright spots when the luminance moment is calculated, however, the luminance moment of each bright spot may be calculated by setting the bright spot center position as an origin. In this case, the luminance moment is divided by the 0-order moment, whereby the difference between the bright spot center position and the centroid position is calculated. The centroid position is calculated by adding this difference to the coordinates of the bright spot center position.

Next, the effect of the phase distribution measuring apparatus 1 is described. Since the centroid operating region is determined according to the position of each bright spot for each frame, the centroid position can be accurately calculated. Furthermore, any lens form and pitch are applicable for designing the fly-eye lens 30.

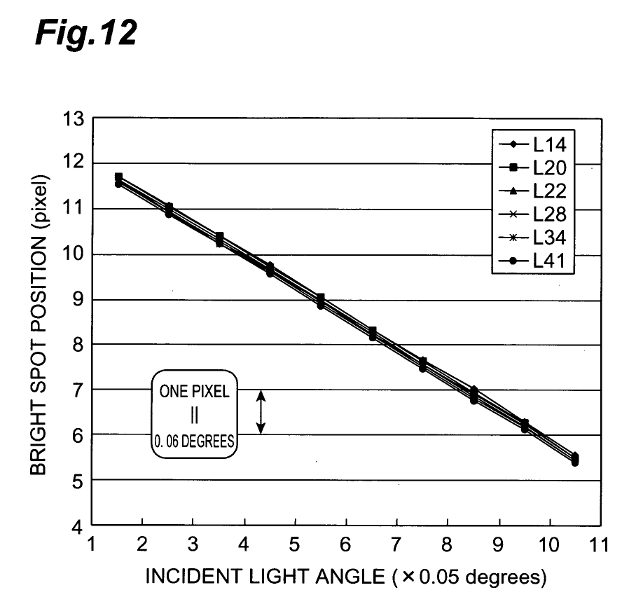

FIG. 12 is a graph showing the relationship between deviation of the centroid position and deviation (phase lag) of the incidence angle of the measuring target laser beam. The horizontal axis shows angles of inclination of the measuring target laser beam, and the vertical axis shows centroid positions (centroid positions of bright spots in the x direction in six blocks). When the incidence angle of the measuring target laser beam was changed by each 0.05 degrees, the centroid position moved by approximately each 0.8 pixels. When the incidence angle was within the range of approximately 0.5 degrees, the relationship between deviation of the centroid position and deviation of the incidence angle (phase lag) of the measuring target laser beam showed excellent linearity, and high-accuracy characteristics of the phase distribution measuring apparatus 1 were confirmed.

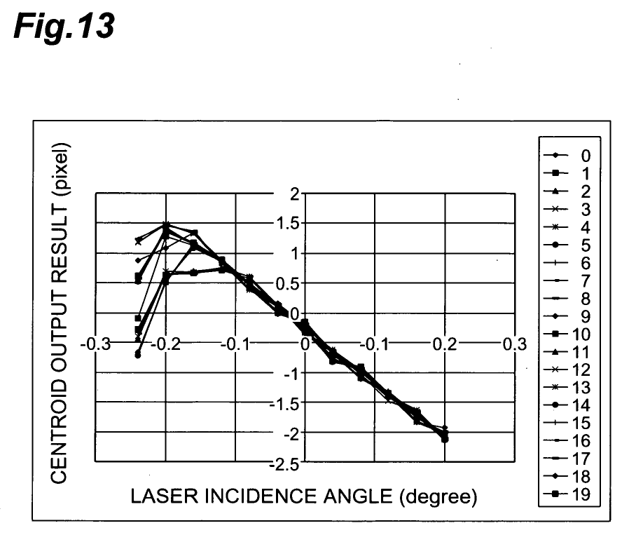

FIG. 13 shows the results of measurement by a phase distribution measuring apparatus in which the centroid operating region for each condensing lens is fixed. When the incidence angle of the measuring target laser beam was gradually changed in the same manner as in FIG. 12, the region showing linearity in the relationship between deviation of the centroid position and deviation of the incidence angle (phase lag) became narrower. Thus, in the phase distribution measuring apparatus in which the centroid operating region for each condensing lens is fixed, when deviation of the incidence angle (phase lag) increases, the actual bright spot region greatly deviates from the centroid operating region, resulting in low operation accuracy.

### INDUSTRIAL APPLICABILITY

The invention is applicable to, for example, astronomical observation apparatuses.

1. A phase distribution measuring apparatus, comprising
a fly-eye lens composed of a plurality of condensing lenses arranged in a matrix on a plane;
an image pickup device which includes a plurality of light receiving elements arranged in a matrix on a light receiving surface, and is arranged so that the light receiving surface becomes parallel to the plane at a distance corresponding to the focal length of the condensing lenses; and
a phase calculating device that calculates a phase distribution of light made incident on the fly-eye lens from data outputted from the image pickup device, wherein
the phase calculating device comprises:
a center position calculation means for calculating bright spot center positions at which the luminance on the light receiving surface becomes maximum based on luminance data detected by each light receiving element; and
a centroid position calculation means for calculating luminance centroid positions in centroid operating regions centered on the bright spot center positions.

2. The phase distribution measuring apparatus according to claim 1, wherein
the phase calculating device further comprises a bright spot area calculation means for calculating areas with luminances exceeding a predetermined threshold in predetermined regions centered on the luminance center positions, and
the centroid operating regions are set so as to occupy areas exceeding the areas calculated by the bright spot area calculation means.

3. The phase distribution measuring apparatus according to claim 1, wherein the center position calculation means calculates the bright spot center positions based only on data of luminances exceeding a predetermined reference value in the luminance data, and
the centroid position calculation means calculates the centroid positions based only on data of luminances exceeding the reference value in the luminance data.

4. The phase distribution measuring apparatus according to claim 2, wherein
the center position calculation means calculates the bright spot center positions based only on data of luminances exceeding a predetermined reference value in the luminance data, and
the centroid position calculation means calculates the centroid positions based only on data of luminances exceeding the reference value in the luminance data.

5. The phase distribution measuring apparatus according to claim 1, wherein
the phase calculating device further comprises a smoothing means
smoothing means that converts luminance data corresponding to each of the light receiving elements into a weighted average of the same and luminance data corresponding to adjacent light receiving elements.

6. The phase distribution measuring apparatus according to claim 2, wherein
a phase calculating device further comprises a smoothing means that converts luminance data corresponding to each of the light receiving elements into a weighted average of the same and luminance data corresponding to adjacent light receiving elements.

7. The phase distribution measuring apparatus according to claim 3, wherein
the phase calculating device further comprises a smoothing means that converts luminance data corresponding to each of the light receiving elements into a weighted average of the same and luminance data corresponding to adjacent light receiving elements.

8. The phase distribution measuring device according to claim 1, wherein
the phase calculating device further comprises a luminance moment calculation means for calculating the moments of luminances in the centroid operating regions,
the center position calculation means and the luminance moment calculation means are formed of a hardware operating circuit, and
the centroid position calculation means calculates the centroid position based on outputs of the hardware operating circuit.

9. The phase distribution measuring device according to claim 2, wherein
the phase calculating device further comprises a luminance moment calculation means for calculating the moments of luminances in the centroid operating regions,
the center position calculation means and the luminance moment calculation means are formed of a hardware operating circuit, and
the centroid position calculation means calculates the centroid position based on outputs of the hardware operating circuit.

10. The phase distribution measuring device according to claim 3, wherein
the phase calculating device further comprises a luminance moment calculation means for calculating the moments of luminances in the centroid operating regions,
the center position calculation means and the luminance moment calculation means are formed of a hardware operating circuit, and
the centroid position calculation means calculates the centroid position based on outputs of the hardware operating circuit.

11. A phase distribution measuring method, comprising:
an imaging step in which light is made incident on a fly-eye lens and focal point images of the light are imaged by an image pickup device;
a luminance data calculating step in which a luminance data calculation means is made to calculate luminance data of light detected by light receiving elements of the image pickup device;
a center position calculating step in which a center position calculation means is made to calculate bright spot center positions at which the luminance becomes maximum on the light receiving surface based on the luminance data;
a centroid position calculating step in which a centroid position calculation means is made to calculate centroid positions of the luminances in centroid operating regions centered on the bright spot center positions; and
a phase calculating step in which a phase calculation means is made to calculate the phase of light made incident on the fly-eye lens based on deviation of the centroid position from a predetermined focal position.

12. The phase distribution measuring method according to claim 11, wherein the centroid position calculating step includes a step of calculating a difference between the bright spot center position and the centroid position and a step of calculating the centroid position from the difference.
